(19) United States
(12) Patent Application Publication
(10) Pub. No.: US 2015/0129183 A1
(43) Pub. Date: May 14, 2015

(54) HEAT EXCHANGER HAVING A COOLER BLOCK AND PRODUCTION METHOD

(71) Applicant: Modine Manufacturing Company, Racine, WI (US)

(72) Inventors: Thomas Peskos, Otisheim (DE); Eugen Auerbach, Stuttgart (DE); Wolfgang Schatz-Knecht, Reutlingen (DE); Thomas Eckert, Waldenbuch (DE); Rainer Glück, Tubingen (DE)

(21) Appl. No.: 14/397,583

(22) PCT Filed: Mar. 28, 2013
(86) PCT No.: PCT/US13/34496

§ 371 Date: Oct. 28, 2014

(30) Foreign Application Priority Data
Apr. 28, 2012 (DE) 102012008700.4

(51) Int. Cl. F28F 3/08; B23P 15/26

(52) U.S. Cl. CPC F28F 3/08; B23P 15/26
USPC 165/166; 29/890.035

(57) ABSTRACT

A heat exchanger having a cooler block including a stack of plates arranged in plate pairs. The cooler block defines flow paths and flow ducts and has an outer circumference. At least some of the plate pairs include a bent edge having an elongation, the elongation on one plate pair in the stack extending to the next plate pair in the stack such that a substantially smooth contour of the cooler block is formed in at least one circumferential region.

### CROSS-REFERENCE TO RELATED APPLICATIONS

This application is a national stage filing under 35 U.S.C. 371 of International Patent Application No. PCT/US2013/034496 filed on Mar. 28, 2013, which claims priority to German Patent Application No. DE102012008700.4, filed Apr. 28, 2012, the entire contents of all of which are hereby incorporated by reference.

### BACKGROUND

The present disclosure relates to a heat exchanger.

### SUMMARY

The disclosure relates to a heat exchanger, for example an indirect air cooler, in which the air, for example compressed charge air of an internal combustion engine, is cooled for example by means of liquid in at least two stages which directly adjoin one another and which are formed in a cooler block which is arranged in a housing, wherein in the cooler block there are arranged flow paths for the liquid, for example, and flow ducts for the air, for example, wherein the air enters into the housing and flows through the flow ducts of the at least two stages in succession.

Charge-air coolers which are installed in motor vehicles and which serve for the cooling of the charge air by means of a cooling liquid are often referred to as indirect air coolers, by contrast to direct air coolers which are referred to if the charge air, for example, is cooled by means of ambient air which is conveyed through the cooler by means of a fan.

The cooling liquid that is used is cooled directly by means of cooling air and is then used for engine cooling and for other cooling purposes, recently also to an increased extent for (indirect) charge-air cooling.

Cooling of the charge air to a lower temperature level is achieved by means of a multi-stage indirect cooling arrangement. GB 2 057 564 A proposes a two-stage charge-air cooling arrangement, wherein the cooling liquid in one stage is extracted from the cooling liquid circuit provided for the cooling of the internal combustion engine. For the other stage, use is made of a cooling liquid which has been cooled further and which originates from a separate cooling liquid circuit. In said reference, to realize the two stages, two heat exchangers are provided which are arranged directly adjacent to one another and through which the charge air flows in succession. In said reference, no more detailed information is given regarding the structural design of the heat exchanger.

In EP 2 412 950 A1 (FIGS. 1 to 5 and description paragraphs 0018 and 0019), to realize the stages, it is likewise the case that two heat exchangers are provided, which heat exchangers are mounted one behind the other and are then assembled to form an integrated unit which is soldered. For the soldering process, the unit must be fixed by means of auxiliary devices, which may be disadvantageous. The unit has collecting tanks, which are of extremely large volume and which are connected to tube plates, for the cooling liquid, as a result of which said unit takes up a large amount of installation space. The soldered unit is inserted into a housing into which the charge air flows and out of which said charge air flows after having flowed through the flow ducts of the heat exchanger.

It is the object of the disclosure primarily to form heat exchangers having simpler structural features, that is to say having structural features which are easy to produce.

The provision of a single stack of plates improves and simplifies the producibility of the cooler block, since the latter need not be assembled from a plurality of blocks. The unipartite form of the plates accordingly eliminates the connection of the blocks to form a unit, and thus reduces at least the outlay for auxiliary devices such as are necessary in the prior art. The disclosure also leads to a more compact heat exchanger, because large-volume collecting tanks for the liquid, for example, are not required.

The plates are deformed plates which are arranged in plate pairs. The flow paths are formed in the plate pairs. The flow ducts are formed between the plate pairs and are preferably filled with cooling ribs.

The flow paths are “closed” flow paths, which is to be understood to mean that the plate edges of the two plates which form a plate pair are connected and closed in an encircling manner. By contrast, the flow ducts are of the “open” type, which is to be understood to mean that the air, for example, can enter freely into the flow ducts of the cooler block on one side and, after flowing though, can emerge from the cooler block again on the opposite side.

Within the context of the present proposal, a single stack of plates should be regarded as being present even if only one plate of each plate pair is of unipartite form. The second plate may be of multi-part, for example two-part, form. The one unipartite plate of each plate pair ensures an inherently connected stack of plates and thus likewise has the effect that blocks need not be connected to one another to form a unit, as mentioned above.

It is preferable if, in the flow paths, there are situated turbulators, preferably lamellae, which are often referred to as “lanced and offset fins”. Such lamellae have one throughflow direction with a relatively high pressure loss and, running perpendicular thereto, one throughflow direction with a relatively low pressure loss.

It is however also possible for plate deformations to project, as turbulence generators, into the flow path of the first stage and for lamellae of the “lanced and offset fins” type to be arranged only in the flow path of the second stage.

It is also possible for inserted turbulators to be dispensed with entirely.

If the single stack of plates is formed from exclusively unipartite deformed plates, the two or more stages are preferably separated from one another by at least one plate deformation. It is thus the case that at least one flow path for one stage and also a flow path for the second stage are provided in the same plate pair.

In one embodiment, it is provided that the charge air, for example, flows through the stage with the higher temperature (first stage) of the liquid, for example, approximately in a cross-flow configuration, and that flow passes through the stage with the lower temperature (second stage) approximately in a countercurrent configuration with respect to the liquid, for example.

Simulation calculations carried out by the applicant have, for the heat exchanger of this embodiment, yielded a considerable increase in the rate of heat exchange in relation to the prior art.

A heat exchanger which can be used in a further field of use in relation to the heat exchanger according to Patent claim 1, having a cooler block composed of a stack of plates which are arranged in plate pairs, which cooler block has flow paths and flow ducts, is characterized in that, on plates, at least one selected circumferential region is provided which has an elongation at the bent-up plate edge, wherein the elongation on one plate extends to the edge of the plate of the next plate pair, such that a substantially smooth edge of the heat exchanger is formed. The elongation allows the stack of plates to be joined together more easily, because said plates are centered relative to one another by the elongations.

A method for producing a heat exchanger having a cooler block from plates which form plate pairs, which plates are assembled to form a stack of plates, such that flow paths and flow ducts are formed, is characterized in that the plates are provided, in at least one selected circumferential region, with an elongation at the bent-up plate edge, and are assembled to form the stack in such a way that the elongations form a substantially smooth contour of the cooler block in the circumferential region.

Further features emerge from the dependent patent claims which, merely in order to avoid repetition, are not specified at this juncture. Furthermore, further features and the effects thereof also emerge from the following description of preferred exemplary embodiments, in which reference is made to the appended drawings.

### BRIEF DESCRIPTION OF THE DRAWINGS

FIG. 1 shows a side view of a heat exchanger (first exemplary embodiment).

FIG. 2 shows the plan view of FIG. 1.

FIG. 3 shows the section A-A from FIG. 2.

FIG. 4 shows another side view of the heat exchanger from FIGS. 1 to 3.

FIG. 5 shows the section B-B from FIG. 2.

FIG. 6 shows the section D-D from FIG. 2.

FIG. 7 shows the section C-C from FIG. 2.

FIG. 8 shows the principle of a second exemplary embodiment, in the form of a plan view of a heat exchanger.

FIG. 9 shows a perspective view of a lamella which is used.

FIG. 10 shows the arrangement of the two-stage heat exchanger from FIGS. 1 to 8 in a housing.

FIG. 11 shows a modified exemplary embodiment similar to FIG. 8.

### DETAILED DESCRIPTION

The heat exchangers of the exemplary embodiments are indirect charge-air coolers. Other uses or possible applications of the proposed heat exchanger are also possible in principle. Usage as an exhaust-gas recirculation cooler or as a cooler for a mixture of charge air and exhaust gas is conceivable, for example. Furthermore, the heat exchanger is not restricted to motor vehicle applications.

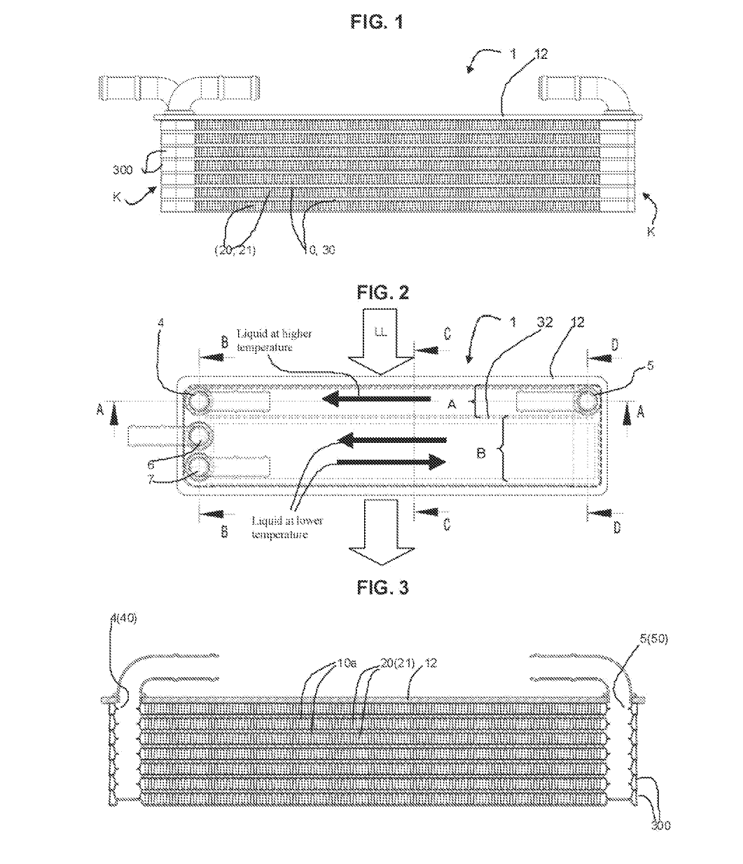

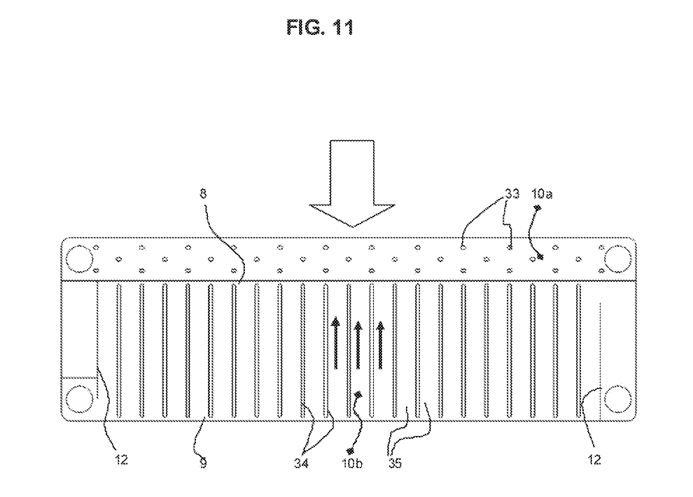

The compressed charge air LL of an internal combustion engine (not shown) is cooled by means of liquid in at least two stages A, B which directly adjoin one another. The stages A, B are formed in a cooler block 1 which is arranged in a housing 2. The cooler block 1 has an upper cover plate 12 which projects beyond a stack 3 of plates 30 and cooling ribs 21 over the entire circumference, such that the cooler block 1 can be fastened by means of the protruding edge of the cover plate 12 to the edge 22 of an insertion opening 23 of the housing 2 (FIG. 10). In the cooler block 1 there are arranged flow paths 10 for the liquid and flow ducts 20 for the charge air. The charge air enters into the housing 2 as per the block arrows plotted in FIGS. 2, 8 and 10, and flows through the flow ducts 20 of the two stages A, B in succession.

As can be seen from the illustrations, the cooler block 1 with the flow paths 10 and the flow ducts 20 in the at least two stages A, B is formed by a single stack 3 of plates 30.

As can also be seen, the flow paths are “closed” flow paths 10, which is to be understood to mean that the plate edges of the two plates 30 which form a plate pair 31 are connected and closed in an encircling manner. By contrast, the flow ducts 20 are of the “open” type, which is to be understood to mean that the air can enter freely into the flow ducts 20 of the cooler block 1 on one side and, after flowing though, can emerge from the cooler block 1 again on the opposite side.

The liquid in the first stage A is at a higher temperature than that flowing through the second stage B. The liquid in the first stage A may be extracted from a coolant circuit (not shown) which serves for the cooling of an internal combustion engine (likewise not shown). The cooler liquid of the second stage B is extracted, in a known manner, from a separate cooling circuit.

The charge air entering the housing 2 flows firstly through the stage A with the higher temperature of the liquid and subsequently through the stage B with the lower temperature, before finally exiting the housing 2 and being available for the supercharging of the internal combustion engine (FIG. 10).

The plates 30 are arranged in plate pairs 31 (already mentioned) in the stack 3. The closed flow paths 10 are formed in the plate pairs 31. Between the plate pairs 31 are situated the open flow ducts 20, which are preferably occupied by cooling ribs 21. The corrugated cooling ribs 21 extend continuously across the at least two stages A, B and are contained in the stack 3 of plates 30 (FIGS. 3 and 7).

In less preferred embodiments, the cooling ribs 21 are replaced (not illustrated) by numerous outward plate deformations (studs) which thus project into the flow ducts 20.

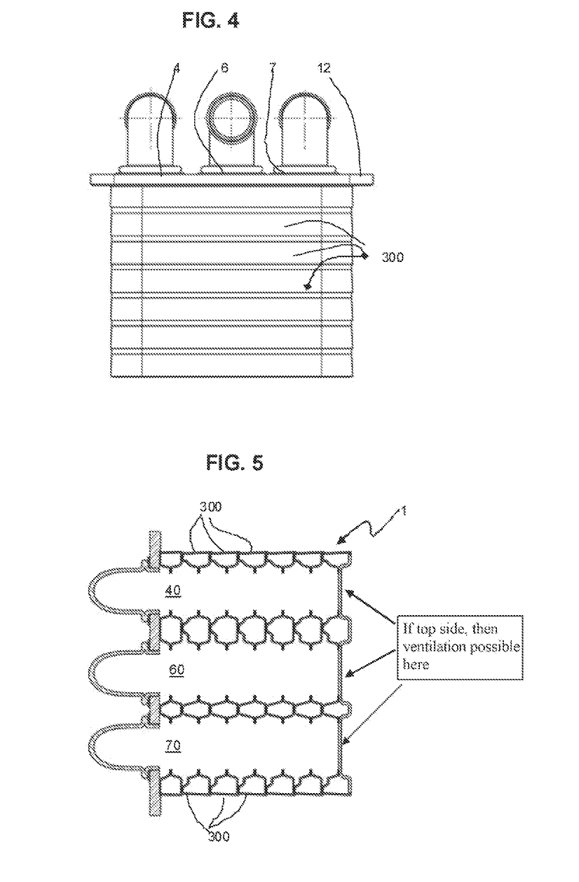

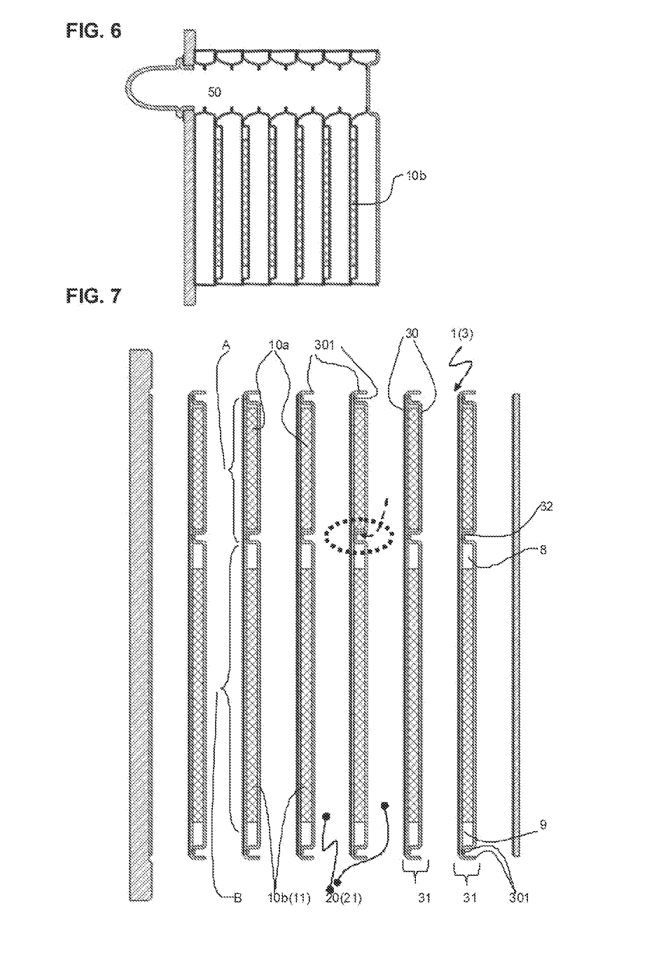

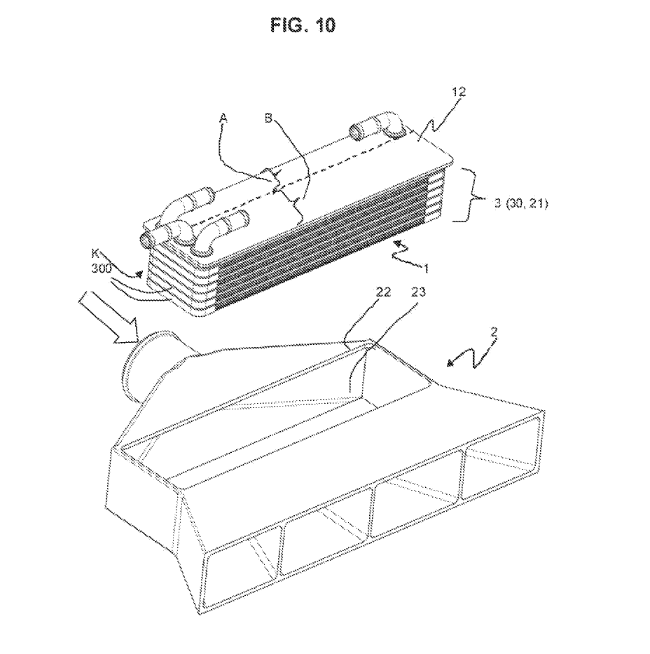

In the exemplary embodiment of FIGS. 1 to 7, lamellae 11 are arranged in the closed flow paths 10 of the two stages A, B. The lamellae 11 that are used are shown in FIG. 9. Said lamellae are “lanced and offset fins”. This is an internationally used term for corrugated ribs with offset wave flanks in which passages 13 are situated. These are known for example from the field of oil cooling. Such “fins” permit a throughflow or passage of the fluid in the longitudinal and transverse directions, wherein the occurring pressure loss dp differs owing to the design of the ribs 11. The throughflow or passage may also be influenced by means of an appropriate configuration of the size of the passages 13 and their spacing to one another.

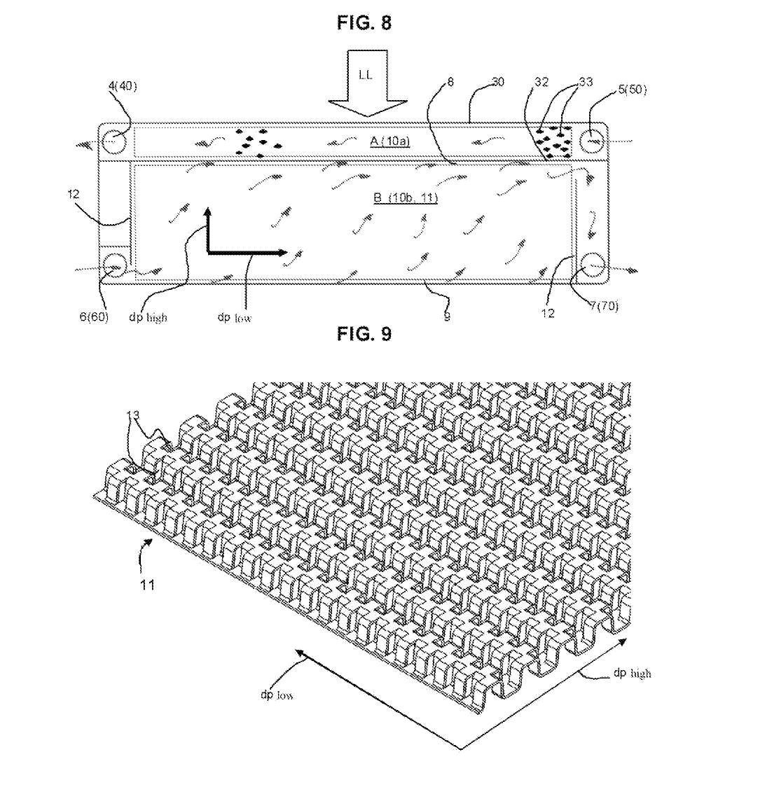

In the exemplary embodiment as per FIG. 8, which will be described in even greater detail below, the use of lamellae 11 in the flow paths 10a of the first stage A has been dispensed with. Instead, studs 33 indicated merely symbolically have been formed into the plates 30 there, which studs extend into the flow path 10a and serve to generate turbulence in the liquid. The studs 33 are preferably provided over the entire length of the flow path 10 even though they have been indicated only at the start and partly in the final third of the length. The described lamellae 11 are arranged in the second stage B.

In the exemplary embodiments shown, all of the plates 30 have been formed as unipartite plates. The unipartite form of the plates 30 yields a single stack 3 of plates 30.

In the exemplary embodiments shown, it is also the case that each stage A, B has only a single flow path 10. In the case of unipartite plates 30 being used, the separation of the flow paths 10 or of the stages A, B is realized by means of a longitudinally extending bead or a deformation 32 in one plate 30 of the plate pairs 31 (FIG. 7). It is possible for such beads 32 to be formed into both plates 30 of each plate pair 31, which beads then exhibit a height approximately half that of the flow path 10 and are connected to one another (not shown).

It is also possible for one of the plates 30 of each plate pair 31 to be of multi-part form such that each flow path 10 may be formed from a portion of a unipartite plate 30 of each plate pair 31 and from a separate plate which is part of the second, multi-part plate. Here, the bead-like, longitudinally extending deformation 32 would be dispensed with or be replaced by long edges, which abut against one another, of plate parts of the multi-part second plate. This has likewise not been illustrated in the exemplary embodiments shown; instead, it has merely been indicated in FIG. 7 by a dashed arrow, highlighted by an oval, where the abutment of the long edges would occur in this case. The advantageous unipartite form of the stack 3 is maintained with this embodiment which is not shown in any more detail.

The plates 30 have inlet and outlet openings 4, 5, 6, 7 with collars surrounding these. The plates 30 are arranged in the stack 3 such that inlet and outlet ducts 40, 50, 60, 70 extending through the stack 3 are formed by means of the collars. Here, the collars in each case bridge the flow ducts 20 and the openings connect the flow paths 10 to one another in terms of flow. This can be seen particularly clearly in the sectional illustrations of FIGS. 3, 5 and 6.

The plates 30 have four such openings 4, 5, 6, 7 with collars. In the exemplary embodiment of FIG. 8, the four openings are arranged approximately in corner regions of the plates 30.

In the exemplary embodiments, the openings are circular openings 4, 5, 6, 7. The shapes of the opening cross sections or the resulting duct cross sections need not be circular but may be formed as appropriate.

In the exemplary embodiment of FIGS. 1 to 7, three openings 4, 6, 7 are arranged on one narrow side of the plates 30 and the fourth opening 5 is arranged in a corner region on the opposite narrow side. This already also defines the flow through the flow paths 10a, 10b in the stages A, B. The liquid flows through the flow path 10a of the first stage A on an approximately straight path in the plate longitudinal direction. The liquid in the flow path 10b of the second stage B passes along at least one outward path and one return path in the plate longitudinal direction, that is to say an approximately U-shaped flow path. The charge air accordingly flows through the first A and the second stage B approximately in a cross-flow configuration with respect to the liquids.

For the exemplary embodiment of FIG. 8, it is provided that the charge air LL flows through the first stage A (with the higher temperature of the liquid) likewise approximately in a cross-flow configuration, and that flow passes through the second stage B (with the lower temperature) approximately in a countercurrent configuration with respect to the liquid. To realize the throughflow approximately in a countercurrent configuration in the simplest possible manner, in each case one duct 8, 9 is arranged in the closed flow path 10b of the second stage B between two edges of the lamellae 11 and two boundaries of the flow path 10b in the plates 30, wherein the liquid flows substantially into one duct 9, flows through the lamellae 11 approximately in a countercurrent configuration with respect to the charge air, and flows out via the other duct 8. In the plates there are arranged flow barriers 12 which force the flow to pass through the ducts 8, 9 and the lamellae 11 approximately in a countercurrent configuration. The ducts 8 and 9 have a very low flow resistance in order that the liquid is distributed easily over the entire length before finally being forced by the flow barriers 12 to flow through the lamellae 11 approximately in countercurrent configuration with respect to LL. By means of the configuration of the lamellae 11 and of the flow barriers 12 and of the ducts 8, 9 as already discussed above, it is also possible to define whether a virtually pure counterflow takes place or only an approximate counterflow takes place.

The remark in FIG. 5 is intended to indicate the possibility of ventilation or degassing of the liquid if, in one exemplary embodiment, the specified side of the cooler block 1 constitutes the top side.

In the exemplary embodiment of FIG. 11, which is similar to FIG. 8, the use of lamellae 11 has been dispensed with entirely. Instead, parallel beads 34 extending in the plate transverse direction have been formed into the plates 30, specifically into those plate regions which serve for forming the flow path 10b. This yields flow lanes 35 in the closed flow paths 10b between the beads 34, which flow lanes connect the two ducts 8 and 9 to one another. Such an alternative configuration, which has however been shown in highly diagrammatic form, permits a “true” counterflow between the liquid in the closed flow paths 10b and the charge air LL in the open flow ducts 20.

In the illustrations of FIGS. 1 to 6, which relate to the first exemplary embodiment, there was also provided an at least idiosyncratic plate design characterized by at least one selected circumferential region of the plates 30 being equipped with a skirt-like elongation 300 of the bent-up plate edge 301 (FIG. 7). In the drawings, two selected circumferential regions are provided which encompass in each case the opposite narrow sides of the plates 30, including the adjoining corner radii, and extend into the long sides of the plates 30. Here, either all of the plates 30, or in each case only one plate 30 of each plate pair 31, may be provided with such elongations 300. In the stack 3, the elongation 300 extends to the edge of the plate 30 of the next plate pair 31 and overlaps said edge to a small extent.

The main purpose of such a design is in the present case that, by means thereof, it is possible to generate on the soldered (or braised or welded) heat exchanger a substantially straight or smooth contour K of the cooler block 1 of the heat exchanger in the region of the elongations 300. This in turn has the advantage that a power-reducing air bypass between the edge (contour K) of the cooler block 1 and the interior of the housing 2 can be more easily suppressed or even avoided entirely. The substantially smooth contour K can be seen from FIGS. 1 and 3 to 6. It can also be seen that, in the selected circumferential region, the flow ducts 20 are not open flow ducts 20 in the sense described above. Specifically, said flow ducts are closed off in the circumferential region by the elongations 300.

Said embodiment however also has other advantages with regard to completely different heat exchanger applications, for example those which do not require a housing 2 and which have no heat exchanger stages A, B. For example, the plates 30 could be more easily assembled to form the stack 3 because a centering action during the course of the formation of the stack 3 can be attributed to the elongations 300. Likewise provided, therefore, is a heat exchanger, for example a water cooler through which cooling air freely flows, which is arranged in the front region of a motor vehicle and which is capable of achieving the object mentioned in the introduction, specifically that of providing, using simple means, a heat exchanger which is easy to produce.

The inventors provide heat exchangers which are inexpensive to produce, exhibit high performance and take up little installation space, that is to say are very compact, and a corresponding production method.

1-22. (canceled)

23. A heat exchanger comprising:
a cooler block including a stack of plates arranged in plate pairs, the cooler block defining flow paths and flow ducts, the cooler block having an outer circumference;
wherein at least some of the plate pairs include a bent edge having an elongation, wherein the elongation on one plate pair in the stack extends to the next plate pair in the stack such that a substantially smooth contour of the cooler block is formed in at least one circumferential region.

24. The heat exchanger of claim 23, wherein the at least one circumferential region includes a first circumferential side of the cooler block and a second circumferential side of the cooler block separated by a gap defined in a circumferential direction between elongations on the first side and elongations on the second side, wherein the flow ducts are closed off in the at least one circumferential region by the elongations, and wherein the gap defines an opening for the flow ducts.

25. The heat exchanger of claim 24, wherein the gap is a first gap, wherein the cooler block further comprises a second gap between the first side and the second side, wherein the first gap is an inlet for the flow ducts and the second gap is an outlet for the flow ducts.

26. The heat exchanger of claim 23, further comprising a housing receiving the cooler block, the housing providing a fluid inlet and a fluid outlet, wherein the cooler block is disposed fluidly between the fluid inlet and the fluid outlet such that the fluid inlet, the flow ducts, and the fluid outlet are fluidly connected.

27. The heat exchanger of claim 26, wherein the housing includes an insertion opening for receiving the cooler block, wherein the cooler block includes a cover plate having a protruding edge for being fastened to the housing.

28. The heat exchanger of claim 26, wherein the housing includes an insertion opening for receiving the cooler block, wherein the insertion opening extends through a top wall of the housing substantially from a first side wall of the housing to a second side wall of the housing.

29. The heat exchanger of claim 28, wherein the at least one circumferential region includes a first side of the cooler block and a second side of the cooler block generally opposite the first side, wherein the first side of the cooler block is disposed adjacent the first side wall of the housing and the second side of the cooler block is disposed adjacent the second side wall of the housing.

30. The heat exchanger of claim 23, wherein each plate pair is formed from a first plate and a second plate, the elongation being formed on the first plate, the heat exchanger further comprising a bead formed in at least one of the first plate or the second plate, the bead separating the plate pair into two stages.

31. A method for producing a heat exchanger, comprising:
forming a cooler block from plates which form plate pairs, which plates are assembled to form a stack of plates, such that flow paths and flow ducts are formed;
providing the plates, in at least one circumferential region, with an elongation at a bent plate edge; and
assembling the plates to form the stack in such a way that the elongations form a substantially smooth contour of the cooler block in the at least one circumferential region.

32. The method of claim 31, wherein the at least one circumferential region includes a first circumferential side of the cooler block and a second circumferential side of the cooler block, the method further comprising:
closing off the flow ducts in the first circumferential side and the second circumferential side by attaching each elongation to the next plate pair; and
forming at least one opening for the flow ducts by forming a gap in a circumferential direction between circumferential regions.

33. The method of claim 32, wherein the opening is an inlet and the gap is a first gap, the method further comprising:
forming an outlet for the flow ducts by forming a second gap in a circumferential direction between circumferential regions.

34. The method of claim 31, further comprising:
inserting the cooler block into a housing providing a fluid inlet and a fluid outlet; and
disposing the cooler block fluidly between the fluid inlet and the fluid outlet such that the fluid inlet, the flow ducts, and the fluid outlet are fluidly connected.

35. The method of claim 34, further comprising:
providing an insertion opening in the housing for receiving the cooler block;
providing a cover plate on the cooler block having a protruding edge; and
fastening the protruding edge to the housing.

36. The method of claim 34, further comprising:
providing an insertion opening in the housing for receiving the cooler block, the insertion opening extending through a top wall of the housing substantially from a first side wall of the housing to a second side wall of the housing.

37. The method of claim 36, wherein the at least one circumferential region includes a first side of the cooler block and a second side of the cooler block generally opposite the first side, the method further comprising:
disposing the first side of the cooler block adjacent the first side wall of the housing and disposing the second side of the cooler block adjacent the second side wall of the housing.

38. The method of claim 23, further comprising:
forming each plate pair from a first plate and a second plate;
forming the elongation on the first plate;
forming a bead in at least one of the first plate or the second plate; and
attaching the bead to the other of the first plate or the second plate to separate the plate pair into two stages.

39. A heat exchanger comprising:
a cooler block including a stack of plates arranged in plate pairs, the cooler block defining flow paths and flow ducts, the cooler block having an outer circumference;
wherein at least some of the plate pairs include a bent edge having an elongation, wherein the elongation on one plate pair in the stack extends to the next plate pair in the stack; and
wherein at least some of the plate pairs include a bead separating the at least some of the plate pairs into two stages, each stage having a separate flow path.

40. The heat exchanger of claim 39, wherein a substantially smooth contour of the cooler block is formed in at least one circumferential region.

41. The heat exchanger of claim 40, wherein the substantially smooth contour of the cooler block is disposed adjacent a wall of a housing when the cooler block is inserted into the housing, wherein the housing includes a fluid inlet and a fluid outlet, wherein the cooler block is disposed fluidly between the fluid inlet and the fluid outlet such that the fluid inlet, the flow ducts, and the fluid outlet are fluidly connected, wherein the flow ducts are closed off in the at least one circumferential region by the elongations.

42. The heat exchanger of claim 39, wherein the at least one circumferential region includes a first circumferential side of the cooler block and a second circumferential side of the cooler block separated by a first gap defined in a circumferential direction between elongations on the first side and elongations on the second side, wherein the flow ducts are closed off in the at least one circumferential region by the elongations, and wherein the first gap defines an opening for the flow ducts, wherein the cooler block further comprises a second gap between the first side and the second side defining another opening for the flow ducts, wherein the first gap is an inlet for the flow ducts and the second gap is an outlet for the flow ducts.
